(19) United States
(12) Patent Application Publication
(10) Pub. No.: US 2026/0063241 A1
(43) Pub. Date: Mar. 5, 2026

(54) PLACEMENT TYPE FIXED PLASTIC SUPPORT

(71) Applicant: Shenzhen Joyhong Tech Co.,Ltd, Shenzhen (CN)

(72) Inventor: Jianping Wang, Shenzhen (CN)

(21) Appl. No.: 19/381,998

(22) Filed: Nov. 6, 2025

(30) Foreign Application Priority Data
Oct. 24, 2025 (CN) 202511526663.1

(51) Int. Cl. F16M 13/00

(52) U.S. Cl. CPC F16M 13/00; F16M 2200/08

(57) ABSTRACT

A placement type fixed plastic support is provided, including a base plate. A raised support barrier strip is fastened to the top of one end of the base plate, and a first diagonal bracing surface is disposed at the other end of the base plate. A support plate is assembled on the first diagonal bracing surface by using quick-disassembling mechanisms. A bent support portion is fixedly connected to one end of the support plate, and a second diagonal bracing surface is disposed at the other end of the support plate. The support plate and the base plate can also be quickly separated when being disassembled, and the operation is convenient and efficient, thereby effectively solving the problem that a traditional support is complex in disassembly and assembly and greatly improving operational efficiency when a structure of the support is adjusted by a user.

### TECHNICAL FIELD

The present disclosure relates to the technical field of supports, in particular to a placement type fixed plastic support.

### BACKGROUND

In daily placement, display, and temporary support scenarios of electronic devices such as tablet computers and e-book readers, and various small precision components, the placement type plastic support occupies specific application portions on the market for a long time by virtue of advantages such as low manufacturing cost, light overall weight, and easy implementation of an injection molding process. However, through thorough exploration of the placement type plastic support in the prior art, it may be found that there are many obvious defects in actual use, which seriously restricts use experience and improvement on product practicability.

Assembling and disassembling mechanisms of existing supports are generally cumbersome and inefficient. Some supports rely on a connection manner that requires assistance of tools such as screws and complex clips or multiple operations. Even if the connection manner is referred to as "quick disassembling", a structural design of the support is not reasonable. Clamping is insufficient in stability and easy to be released, or a separation process still takes a relatively long time. As a result, when a structure of the support is adjusted by a user or the support is completely disassembled and stored, operation efficiency is extremely low, it is difficult to meet a core requirement of a modern user for a convenient operation, and a specific volume is also required during packaging, thereby increasing transportation costs.

In addition, there are obvious shortcomings in support stability and structural durability of an existing support. In particular, in an anti-skid design, most of existing supports are only provided with a simple anti-skid pad disposed on a surface of a base plate, and side limitation for a supported device and skid prevention for a support component and a placement surface are not systematically considered. A sliding risk of the supported device is easily caused. In terms of structural strength, because of a lack of scientific layout of reinforcing ribs, insufficient overall rigidity of the support, long-term endurance of a support force, or collision of a slight impact force, a problem such as deformation or cracking easily occurs, which directly affects a support effect and a service life of a product, and also greatly limits an application range of the support.

### SUMMARY

An objective of the present disclosure is to provide a placement type fixed plastic support, so as to solve the problems mentioned in the background art.

To achieve the foregoing objective, the present disclosure provides the following technical solution. A placement type fixed plastic support includes a base plate, where a raised support barrier strip is fastened to the top of one end of the base plate, a first diagonal bracing surface is disposed at the other end of the base plate, a support plate is assembled on the first diagonal bracing surface by using quick-disassembling mechanisms, a bent support portion is fixedly connected to one end of the support plate, a second diagonal bracing surface is disposed at the other end of the support plate, and when the support plate is assembled with the base plate, the second diagonal bracing surface precisely abuts against the first diagonal bracing surface; and the quick-disassembling mechanism includes a convex-shaped clamping hole formed in a surface of the first diagonal bracing surface, the convex-shaped clamping hole is in clamping connection with a T-shaped plug post fixedly connected to a surface of the second diagonal bracing surface, the quick-disassembling mechanism further includes a plurality of positioning recesses formed in the surface of the first diagonal bracing surface, and the positioning recesses are in clamping connection with positioning protrusions fixedly connected to the surface of the second diagonal bracing surface.

As a preferred solution of the present disclosure, a first anti-skid silica gel pad is fixedly connected to the inner side of the support barrier strip and a surface of the base plate, a plurality of first reinforcing ribs are fixedly connected to the interior of the bottom of the base plate, and second anti-skid silica gel pads are fixedly connected to both sides of the bottom of the base plate.

As a preferred solution of the present disclosure, indication identifiers for unlocking and locking are disposed on both ends of the surface of the first diagonal bracing surface, and the indication identifier includes an arrow identification slot and a lock body identification slot.

As a preferred solution of the present disclosure, a plurality of second reinforcing ribs are fixedly connected to the inner side of the support plate, a hollowed-out slot is formed in the middle of the support plate, and a third anti-skid silica gel pad is fixedly connected to the outer side of the bent support portion.

As a preferred solution of the present disclosure, a wedge-shaped chamfer portion is disposed at an inner turning position of the convex-shaped clamping hole, and a hole depth of the convex-shaped clamping hole is the same as a post length of the T-shaped plug post.

As a preferred solution of the present disclosure, the base plate, the quick-disassembling mechanism, and the support plate are all made of a plastic material, and the base plate and the support plate are injection-molded integrally.

As a preferred solution of the present disclosure, the middle of the bottom of the support plate is in clamping connection with a foldable auxiliary supporting mechanism, the auxiliary supporting mechanism includes an auxiliary base plate, a plurality of raised fixture blocks are fixedly connected to the top of the auxiliary base plate, the raised fixture blocks are connected to the bottom of the support plate by using grooves formed by the second reinforcing ribs, and folding plates are connected to both ends of the auxiliary base plate by using rotating mechanisms.

As a preferred solution of the present disclosure, when the folding plate is folded over at the bottom of the auxiliary base plate, the bottom of the folding plate keeps flush with the bottom of the third anti-skid silica gel pad.

As a preferred solution of the present disclosure, the rotating mechanism includes an L-shaped plug pin fixedly connected to one end of the folding plate, the L-shaped plug pin is in inserted connection with a sleeve disposed at an end of the base plate, and the L-shaped plug pin and the sleeve are made of a plastic material.

As a preferred solution of the present disclosure, a support cushion plate is cushioned between the second diagonal bracing surface and the first diagonal bracing surface, a convex-shaped clamping hole and an indication identifier are also disposed on a surface of the support cushion plate, positioning protrusions are also fixedly connected to a surface of the support cushion plate, positioning recesses are also formed in the bottom of the support cushion plate, and after the support cushion plate is cushioned, a post length of the T-shaped plug post is adapted to a depth from the second diagonal bracing surface to the positioning recess of the support cushion plate.

Compared with the prior art, the present disclosure has the following beneficial effects.

1) In the present disclosure, by using the quick-disassembling mechanisms, the convex-shaped clamping hole formed in the first diagonal bracing surface and the T-shaped plug post fastened to the second diagonal bracing surface are used to implement precise clamping. In addition, the positioning recesses on the first diagonal bracing surface cooperate with the positioning protrusions on the second diagonal bracing surface for auxiliary clamping. By using clamping and auxiliary positioning structures, the support plate and the base plate can be assembled only by simple plugging actions. The support plate and the base plate can also be quickly separated when being disassembled, and the operation is convenient and efficient, thereby effectively solving the problem that a traditional support is complex in disassembly and assembly and greatly improving operational efficiency when the support structure is adjusted by a user. Moreover, the volume of the disassembled support during packaging is also reduced to a certain extent, and the support is convenient to transport and sell.

2) In the present disclosure, the first anti-skid silica gel pads on the inner side of the support barrier strip and the surface of the base plate can form omni-directional anti-skid limitation on side edges and a bottom surface of the supported device, thereby effectively avoiding the device from sliding off. The second anti-skid silica gel pads on both sides of the bottom of the base plate enhance a frictional force between the support itself and a placement surface, and further improve overall placement stability. The third anti-skid silica gel pad on the outer side of the bent support portion can perform anti-skid reinforcement on a contact part of the supported device, thereby eliminating anti-skid hidden dangers in multiple dimensions. The plurality of first reinforcing ribs inside the base plate and the plurality of second reinforcing ribs on the inner side of the support plate greatly improve overall rigidity and deformation resistance of the support even if the support endures long-term bracing force or encounters an external force, and also can effectively avoid deformation and cracking, thereby obviously prolonging a service life of the support.

3) In the present disclosure, the indication identifiers for unlocking and locking disposed at both ends of the surface of the first diagonal bracing surface provide clear and intuitive visual guidance for user operation, thereby greatly reducing learning costs and error rate of quick-disassembling operations. A design of the auxiliary supporting mechanism and the support cushion plate extends a functional boundary and an applicable scenario of the support. The auxiliary supporting mechanism is in clamping connection with the grooves formed by the second reinforcing ribs at the bottom of the support plate by using the raised fixture blocks of the auxiliary base plate. Moreover, the folding plates are connected to both ends of the auxiliary base plate by using the rotating mechanisms, and the folding plates can be folded over according to requirements to cooperate with the base plate so as to jointly support a large device. The convex-shaped clamping holes and the indication identifiers adapted to the quick-disassembling mechanism are formed in the surface of the support cushion plate, and the support cushion plate is further provided with the positioning protrusions and the positioning recesses. After the support cushion plate is cushioned, a cooperative height of the support plate and the base plate can be changed. Combination between the support plate and the base plate can precisely adapt support requirements of devices of different sizes and different types. The support is also applicable to diversified use scenarios, which greatly enhances the use flexibility and applicability of the support.

### BRIEF DESCRIPTION OF THE DRAWINGS

FIG. 1 is a structural schematic diagram according to the present disclosure;

FIG. 2 is one of structural schematic diagrams according to the present disclosure;

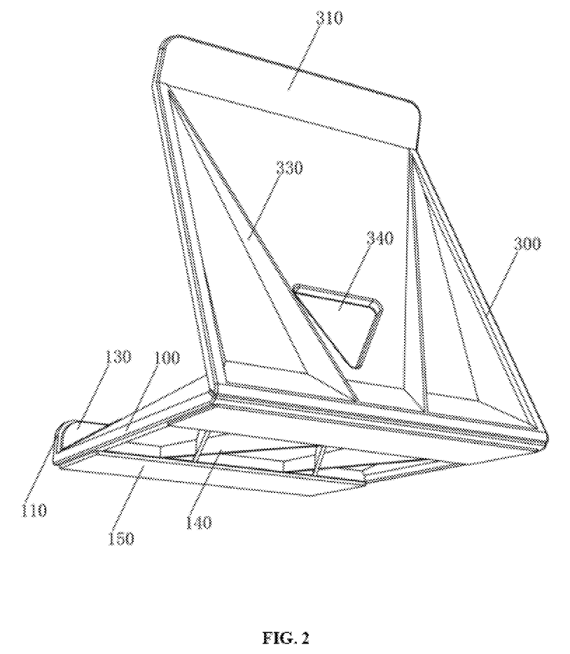

FIG. 3 is a split schematic diagram according to the present disclosure;

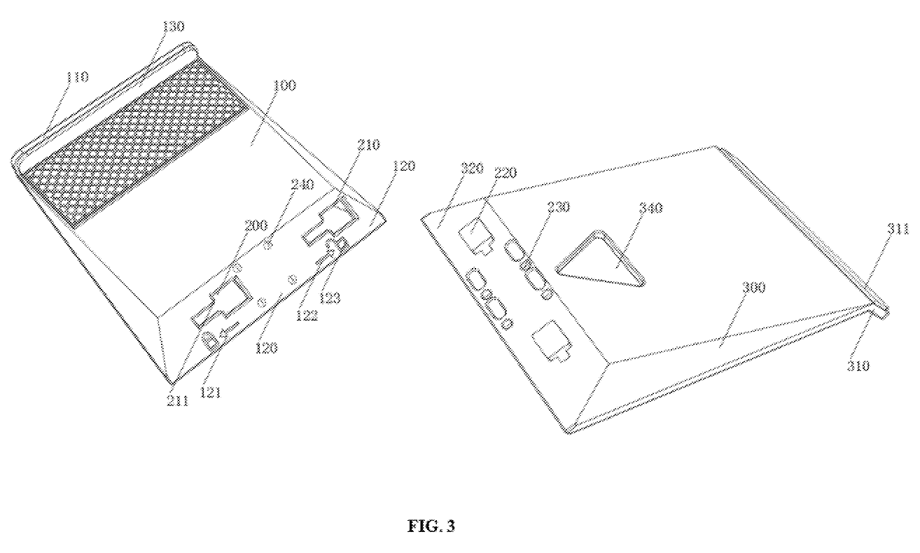

FIG. 4 is a structural schematic diagram of a groove according to Embodiment 2 of the present disclosure;

FIG. 5 is a structural schematic diagram of an auxiliary supporting mechanism according to Embodiment 2 of the present disclosure;

FIG. 6 is a structural schematic diagram of a rotating mechanism according to Embodiment 2 of the present disclosure;

FIG. 7 is a structural schematic diagram of a folding plate according to Embodiment 2 of the present disclosure; and

FIG. 8 is a structural schematic diagram according to Embodiment 3 of the present disclosure.

Reference numerals: 100: base plate; 110: support barrier strip; 120: first diagonal bracing surface; 130: first anti-skid silica gel pad; 140: first reinforcing rib; 150: second anti-skid silica gel pad; 121: indication identifier; 122: arrow identification slot; 123: lock body identification slot; 200: quick-disassembling mechanism; 210: convex-shaped clamping hole; 211: wedge-shaped chamfer portion; 220: T-shaped plug post; 230: positioning recess; 240: positioning protrusion; 300: support plate; 310: bent support portion; 311: third anti-skid silica gel pad; 320: second diagonal bracing surface; 330: second reinforcing rib; 340: hollowed-out slot; 400: auxiliary supporting mechanism; 410: auxiliary base plate; 420: raised fixture block; 430: groove; 440: rotating mechanism; 441: L-shaped plug pin; 442: sleeve; 450: folding plate; and 500: support cushion plate.

### DETAILED DESCRIPTION OF THE EMBODIMENTS

The following clearly and completely describes technical solutions in embodiments of the present disclosure with reference to drawings in the embodiments of the present disclosure. Apparently, the described embodiments are merely a part rather than all of the embodiments of the present disclosure. All other embodiments obtained by those skilled in the art on the basis of the embodiments of the present disclosure without requiring the exercise of inventive effort fall within the scope of protection of the present disclosure.

### Embodiment 1

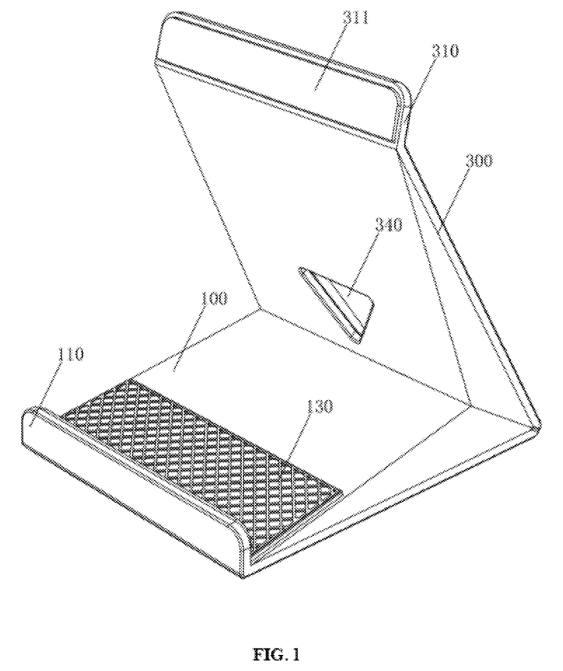

Referring to FIGS. 1to3, the present disclosure provides a technical solution. A placement type fixed plastic support includes a base plate 100. A raised support barrier strip 110 is fastened to the top of one end of the base plate 100, and a first diagonal bracing surface 120 is disposed at the other end of the base plate 100. A support plate 300 is assembled on the first diagonal bracing surface 120 by using quick-disassembling mechanisms 200. A bent support portion 310 is fixedly connected to one end of the support plate 300, and a second diagonal bracing surface 320 is disposed at the other end of the support plate 300. When the support plate 300 is assembled with the base plate 100, the second diagonal bracing surface 320 precisely abuts against the first diagonal bracing surface 120.

The quick-disassembling mechanism 200 includes a convex-shaped clamping hole 210 formed in a surface of the first diagonal bracing surface 120. The convex-shaped clamping hole 210 is in clamping connection with a T-shaped plug post 220 fixedly connected to a surface of the second diagonal bracing surface 320. The quick-disassembling mechanism 200 further includes a plurality of positioning recesses 230 formed in the surface of the first diagonal bracing surface 120. The positioning recesses 230 are in clamping connection with positioning protrusions 240 fixedly connected to the surface of the second diagonal bracing surface 320.

Specifically, when electronic devices such as tablet computers need to be supported by the placement type fixed plastic support, first the base plate 100 is placed smoothly on a desktop. The support barrier strip 110 faces a user side to limit the bottom of the device, and then the support plate 300 is lifted. The T-shaped plug post 220 on the second diagonal bracing surface 320 is aligned with the convex-shaped clamping hole 210 on the first diagonal bracing surface 120 of the base plate 100, and is inserted along a contour of the hole. The T-shaped structure may limit left-and-right sliding, so as to implement initial clamping. In addition, the positioning protrusions 240 on the second diagonal bracing surface 320 may be accurately clamped into the positioning recesses 230 on the first diagonal bracing surface 120. A plurality of positioning combinations take effect synchronously, which ensures that the second diagonal bracing surface 320 tightly abuts against the first diagonal bracing surface 120 without front-and-backing shaking, and also improves clamping stability. After assembling is completed, the back of the electronic device leans against the bent support portion 310 of the support plate 300, and the bottom of the electronic device abuts against the support barrier strip 110, so as to form stable tilt support and facilitate viewing and operation.

When storage is needed, the support plate 300 is pushed backwards, so that the T-shaped plug post 220 slides out of the convex-shaped clamping hole 210 and the positioning protrusions 240 are separated from the positioning recesses 230, that is, the base plate and the support plate can be quickly disassembled to facilitate carrying.

In this embodiment, a first anti-skid silica gel pad 130 is fixedly connected to the inner side of the support barrier strip 110 and a surface of the base plate 100. A plurality of first reinforcing ribs 140 are fixedly connected to the interior of the bottom of the base plate 100. Second anti-skid silica gel pads 150 are fixedly connected to both sides of the bottom of the base plate 100.

Specifically, in a process of supporting the electronic device, the first anti-skid silica gel pad 130 on the surface of the base plate 100 and on the inner side of the support barrier strip 110 may make full contact with the surface of the device, and a high friction characteristic of silica gel is used to increase a frictional force between the device and the support, so as to prevent the device from sliding when a user touches a screen, thereby ensuring device safety.

Like internal skeletons, the plurality of first reinforcing ribs 140 inside the bottom of the base plate 100 can effectively disperse device pressure endured by the base plate, thereby greatly improving structural strength and rigidity of the base plate, avoiding bending deformation of the base plate 100 caused by long-term support, and prolonging a service life of the support. In addition, the second anti-skid silica rubber pads 150 on both sides of the bottom of the base plate 100 are in contact with the desktop, so as to increase a frictional force between the overall support and the desktop. Even if the desktop is tilted or slightly impacted, the support can be stably placed, thereby further enhancing support stability.

In this embodiment, indication identifiers 121 for unlocking and locking are disposed at both ends of the surface of the first diagonal bracing surface 120, and the indication identifier 121 includes an arrow identification slot 122 and a lock body identification slot 123.

Specifically, when the support plate 300 is assembled or disassembled, the indication identifiers 121 at both ends of the surface of the first diagonal bracing surface 120 provide clear operation guidance for the user. The arrow identification slot 122 may clearly indicate a direction in which the T-shaped plug post 220 is inserted into the convex-shaped clamping hole 210, so as to help the user with quick alignment, thereby improving assembly efficiency. The lock body identification slot 123 may be used to prompt a clamping state, and is applicable to a user who is not familiar with the first use or operation, thereby reducing the difficulty and error rate of the quick-disassembling operation.

In this embodiment, a plurality of second reinforcing ribs 330 are fixedly connected to the inner side of the support plate 300. A hollowed-out slot 340 is formed in the middle of the support plate 300. A third anti-skid silica gel pad 311 is fixedly connected to the outer side of the bent support portion 310.

Specifically, the plurality of second reinforcing ribs 330 on the inner side of the support plate 300 are distributed in a grid shape, and can effectively disperse pressure applied on the back of the electronic device, thereby enhancing structural strength of the support plate 300, and preventing deformation caused by long-term support. The hollowed-out slot 340 in the middle reduces the weight of the support plate on the premise of ensuring strength, so that the support plate is lighter and convenient to carry.

When the electronic device leans against the bent support portion 310, the third anti-skid silica gel pad 311 on the outer side of the bent support portion 310 makes contact with the back of the device. The frictional force is increased by using an anti-skid performance of silica gel. Even if the surface of the device is smooth, the support can be stabilized, so as to ensure that a support angle is not offset and improve use experience.

In this embodiment, a wedge-shaped chamfer portion 211 is disposed at an inner turning position of the convex-shaped clamping hole 210, and a hole depth of the convex-shaped clamping hole 210 is the same as a post length of the T-shaped plug post 220.

Specifically, when the support plate 300 is assembled, in a process of inserting the T-shaped plug post 220 into the convex-shaped clamping hole 210, the wedge-shaped chamfer portion 211 at the inner turning position of the convex-shaped clamping hole 210 may play a guiding role, so as to guide the T-shaped plug post 220 to slide into the convex-shaped clamping hole 210 more smoothly, so as to avoid difficulty of clamping due to an alignment precision problem and improve assembly smoothness. The hole depth of the convex-shaped clamping hole 210 is the same as the post length of the T-shaped plug post 220, and it is ensured that there is no redundant gap after the T-shaped plug post 220 is completely inserted, so that clamping is tighter, and connection stability of the quick-disassembling mechanism is enhanced, the support plate 300 is prevented from shaking due to the gap when in use, and the support stability is further ensured.

In this embodiment, the base plate 100, the quick-disassembling mechanism 200, and the support plate 300 are all made of a plastic material, and the base plate 100 and the support plate 300 are injection-molded integrally.

Specifically, the base plate 100, the quick-disassembling mechanism 200, and the support plate 300 are made of a plastic material, and excellent plastic injection molding performance is used. Therefore, the base plate 100 and the support plate 300 may be fabricated by using an integrated injection molding process. The integrated injection molding can not only ensure dimensional precision of cooperative structures such as the convex-shaped clamping hole 210 and the T-shaped plug post 220, but also improve tightness and stability of clamping, simplify a production process and reduce manufacturing costs. In addition, a low-weight characteristic of plastic makes the whole support lighter and convenient to carry and move, and the plastic is high in corrosion resistance, and can adapt to multiple use environments, thereby prolonging the service life of the support.

### Embodiment 2

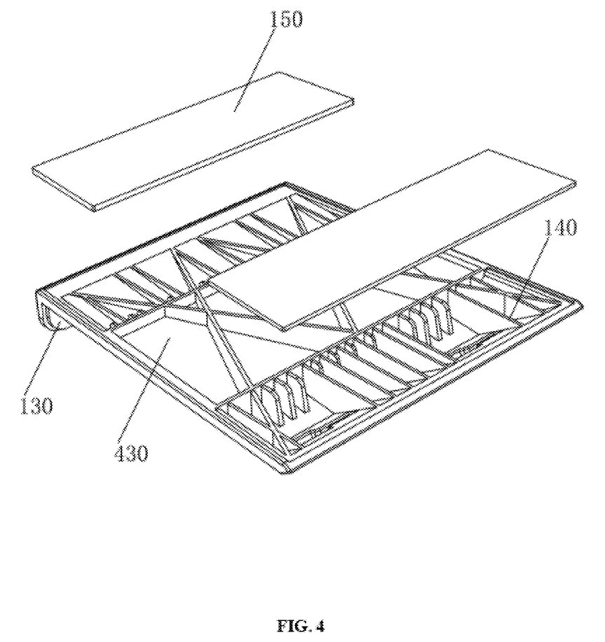

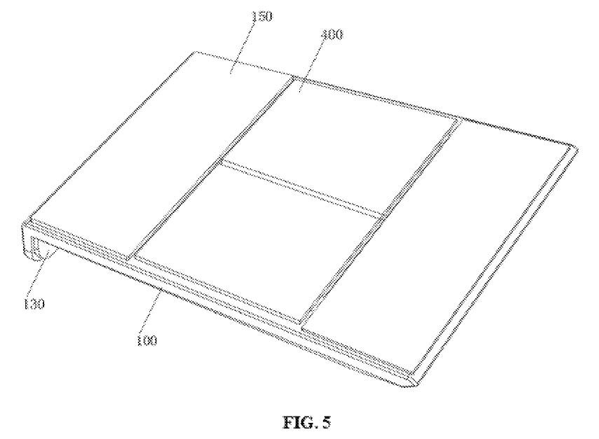

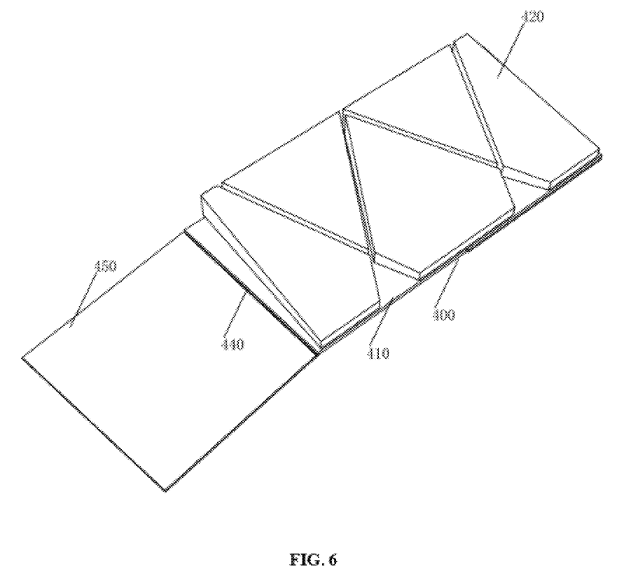

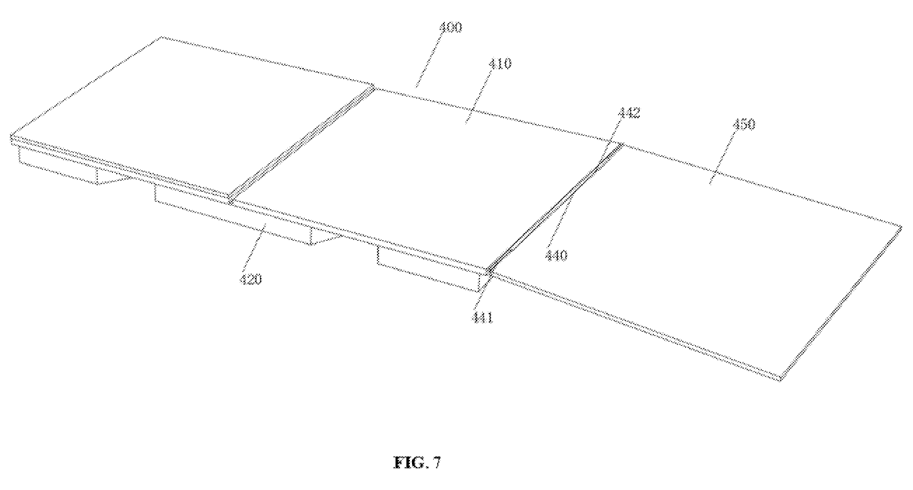

Referring to FIGS. 4 to 7, a technical feature that distinguishes this embodiment from Embodiment 1 is as follows. The middle of the bottom of the support plate 300 is in clamping connection with a foldable auxiliary supporting mechanism 400. The auxiliary supporting mechanism 400 includes an auxiliary base plate 410. A plurality of raised fixture blocks 420 are fixedly connected to the top of the auxiliary base plate 410. The raised fixture blocks 420 are connected to the bottom of the support plate 300 by using grooves 430 formed by the second reinforcing ribs 330. Folding plates 450 are connected to both ends of the auxiliary base plate 410 by using rotating mechanisms 440.

Specifically, when the support needs to be used to support a device with a large volume, such as a large-sized tablet computer, the raised fixture locks 420 on the top of the auxiliary base plate 410 of the auxiliary supporting mechanism may be first aligned with the grooves 430 formed by the second reinforcing ribs 330 at the bottom of the support plate 300 for clamping, so that the auxiliary supporting mechanism is fastened to the middle of the bottom of the support plate 300, and then the folding plate 450 is adjusted by using the rotating mechanism 440. The folding plate 450 may be folded over from the bottom of the auxiliary base plate 410, so that the folding plate cooperates with the auxiliary base plate 410 to make contact with the desktop together, thereby ensuring stability of supporting and placing the device with a large size. If auxiliary support is not required, the folding plate is folded over to the bottom of the auxiliary base plate 410 without affecting conventional use of the support, thereby improving the applicability of the support.

In this embodiment, when the folding plate 450 is folded over at the bottom of the auxiliary base plate 410, the bottom of the folding plate 450 keeps flush with the bottom of the third anti-skid silica gel pad 311.

Specifically, when the folding plate 450 is folded over at the bottom of the auxiliary base plate 410, the bottom of the folding plate 450 is flush with the bottom of the third anti-skid silica rubber pad 311, so that when the auxiliary supporting mechanism 400 is not used, a contact surface of the bottom of the support is flush and uniform, the support is more tidy in appearance, and the folding plate 450 is avoided from protruding to affect placement stability and attractive appearance.

In this embodiment, the rotating mechanism 440 includes an L-shaped plug pin 441 fixedly connected to one end of the folding plate 450, the L-shaped plug pin 441 is in inserted connection with a sleeve 442 disposed at an end of the auxiliary base plate 410, and the L-shaped plug pin 441 and the sleeve 442 are made of a plastic material.

Specifically, when an angle of the folding plate 450 of the auxiliary supporting mechanism 400 is adjusted, because the L-shaped plug pin 441 and the sleeve 442 are made of a plastic material, toughness and damping feel of the plastic may enable the L-shaped plug pin 441 to rotate inside the sleeve 442 by applying force when the angle is adjusted by the user. After the angle is adjusted to a required angle, damping of the plastic can enable the L-shaped plug pin 441 to remain at the angle, so as to fix a position of the folding plate 450. In addition, the plastic rotating mechanism 440 is simple to manufacture and low in costs, and can provide proper rotation damping. The angle is convenient to adjust, and it can be ensured that the folding plate 450 is not prone to rotate at random, thereby improving stability of auxiliary support.

### Embodiment 3

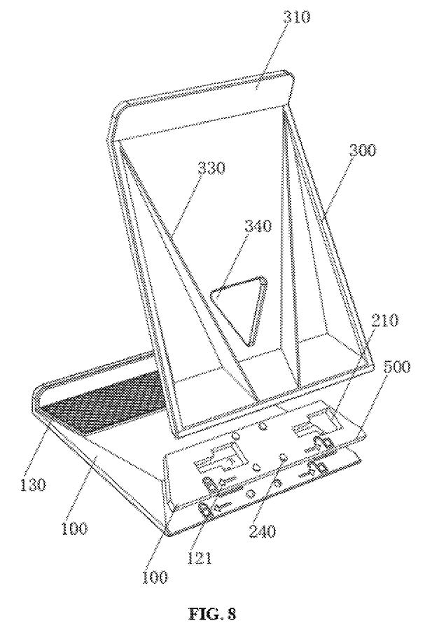

Referring to FIG. 8, a technical feature of this embodiment that distinguishes this embodiment from Embodiment 1 is as follows. A support cushion plate 500 is cushioned between the second diagonal bracing surface 320 and the first diagonal bracing surface 120. A convex-shaped clamping hole 210 and an indication identifier 121 are also disposed on a surface of the support cushion plate 500. Positioning protrusions 240 are also fixedly connected to a surface of the support cushion plate 500. Positioning recesses 230 are also formed in the bottom of the support cushion plate 500. After the support cushion plate 500 is cushioned, a post length of the T-shaped plug post 220 is adapted to a depth from the second diagonal bracing surface 320 to the positioning recess 230 of the support cushion plate 500.

Specifically, when a support height of the support plate 300 of the support needs to be changed, the support cushion plate 500 may be cushioned. First, the support cushion plate 500 is placed on the first diagonal bracing surface 120 of the base plate 100, so that the positioning recesses 230 on the surface of the support cushion plate 500 are clamped with the positioning protrusions 240 on the first diagonal bracing surface 120, so as to implement initial fixation of the support cushion plate 500. Then, the T-shaped plug post 220 on the second diagonal bracing surface 320 of the support plate 300 passes through the convex-shaped clamping hole 210 on the surface of the support plate 500, and then is inserted into the convex-shaped clamping hole 210 on the first diagonal bracing surface of the base plate 100. In addition, the positioning protrusions 230 of the support plate 300 are clamped into the positioning recesses 230 on the surface of the support plate 500. In this case, the post length of the T-shaped plug post 220 is adapted to the depth from the second diagonal bracing surface 320 to the positioning recess 230 of the support cushion plate 500, so as to ensure clamping tightness. By cushioning the support cushion plate 500, a distance between the base plate 100 and the support plate 300 is increased, and an overall support height is increased, so that the support is adapted to a scenario of a thick device or a special height requirement, and an application range of the support is further expanded.

Details not described herein are known to a person of ordinary skill in the art. Although the present disclosure has been described in detail with reference to the foregoing embodiments, for those skilled in the art, modifications may still be made to the subject matter recited in the foregoing embodiments, or equivalents may be substituted for some of the technical features thereof. Any modification, equivalent replacement, or improvement made without departing from the spirit and principle of the present disclosure shall fall within the protection scope of the present disclosure.

What is claimed is:

1. A placement type fixed plastic support, comprising a base plate (100), wherein a raised support barrier strip (110) is fastened to the top of one end of the base plate (100), a first diagonal bracing surface (120) is disposed at the other end of the base plate (100), a support plate (300) is assembled on the first diagonal bracing surface (120) by using quick-disassembling mechanisms (200), a bent support portion (310) is fixedly connected to one end of the support plate (300), a second diagonal bracing surface (320) is disposed at the other end of the support plate (300), and when the support plate (300) is assembled with the base plate (100), the second diagonal bracing surface (320) precisely abuts against the first diagonal bracing surface (120); and
the quick-disassembling mechanism (200) comprises a convex-shaped clamping hole (210) formed in a surface of the first diagonal bracing surface (120), the convex-shaped clamping hole (210) is in clamping connection with a T-shaped plug post (220) fixedly connected to a surface of the second diagonal bracing surface (320), the quick-disassembling mechanism (200) further comprises a plurality of positioning recesses (230) formed in the surface of the first diagonal bracing surface (120), and the positioning recesses (230) are in clamping connection with positioning protrusions (240) fixedly connected to the surface of the second diagonal bracing surface (320).

2. The placement type fixed plastic support according to claim 1, wherein a first anti-skid silica gel pad (130) is fixedly connected to the inner side of the support barrier strip (110) and a surface of the base plate (100), a plurality of first reinforcing ribs (140) are fixedly connected to the interior of the bottom of the base plate (100), and second anti-skid silica gel pads (150) are fixedly connected to both sides of the bottom of the base plate (100).

3. The placement type fixed plastic support according to claim 1, wherein indication identifiers (121) for unlocking and locking are disposed at both ends of the surface of the first diagonal bracing surface (120), and the indication identifier (121) comprises an arrow identification slot (122) and a lock body identification slot (123).

4. The placement type fixed plastic support according to claim 1, wherein a plurality of second reinforcing ribs (330) are fixedly connected to the inner side of the support plate (300), a hollowed-out slot (340) is formed in the middle of the support plate (300), and a third anti-skid silica gel pad (311) is fixedly connected to the outer side of the bent support portion (310).

5. The placement type fixed plastic support according to claim 1, wherein a wedge-shaped chamfer portion (211) is disposed at an inner turning position of the convex-shaped clamping hole (210), and a hole depth of the convex-shaped clamping hole (210) is the same as a post length of the T-shaped plug post (220).

6. The placement type fixed plastic support according to claim 1, wherein the base plate (100), the quick-disassembling mechanism (200), and the support plate (300) are all made of a plastic material, and the base plate (100) and the support plate (300) are injection-molded integrally.

7. The placement type fixed plastic support according to claim 1, wherein the middle of the bottom of the support plate (300) is in clamping connection with a foldable auxiliary supporting mechanism (400), the auxiliary supporting mechanism (400) comprises an auxiliary base plate, a plurality of raised fixture blocks (420) are fixedly connected to the top of the auxiliary base plate, the raised fixture blocks (420) are connected to the bottom of the support plate (300) by using grooves (430) formed by the second reinforcing ribs (330), and folding plates (450) are connected to both ends of the auxiliary base plate by using rotating mechanisms (440).

8. The placement type fixed plastic support according to claim 7, wherein when the folding plate (450) is folded over at the bottom of the auxiliary base plate, the bottom of the folding plate (450) keeps flush with the bottom of the third anti-skid silica gel pad (311).

9. The placement type fixed plastic support according to claim 7, wherein the rotating mechanism (440) comprises an L-shaped plug pin (441) fixedly connected to one end of the folding plate (450), the L-shaped plug pin (441) is in inserted connection with a sleeve (442) disposed at an end of the auxiliary base plate, and the L-shaped plug pin (441) and the sleeve (442) are made of a plastic material.

10. The placement type fixed plastic support according to claim 1, wherein a support cushion plate (500) is cushioned between the second diagonal bracing surface (320) and the first diagonal bracing surface (120), a convex-shaped clamping hole (210) and an indication identifier (121) are also disposed on a surface of the support cushion plate (500), positioning protrusions (240) are also fixedly connected to a surface of the support cushion plate (500), positioning recesses (230) are also formed in the bottom of the support cushion plate (500), and after the support cushion plate (500) is cushioned, a post length of the T-shaped plug post (220) is adapted to a depth from the second diagonal bracing surface (320) to the positioning recess (230) of the support cushion plate (500).
